(19) United States
(12) Patent Application Publication
(10) Pub. No.: US 2025/0229529 A1
(43) Pub. Date: Jul. 17, 2025

(54) LIQUID EJECTION HEAD

(71) Applicant: CANON KABUSHIKI KAISHA, Tokyo (JP)

(72) Inventor: SEIICHIRO YAGINUMA, Kanagawa (JP)

(21) Appl. No.: 18/983,582

(22) Filed: Dec. 17, 2024

(30) Foreign Application Priority Data
Jan. 12, 2024 (JP) 2024-003362

(51) Int. Cl. B41J 2/14

(52) U.S. Cl. CPC B41J 2/14201; B41J 2/14016; B41J 2002/14306; B41J 2002/14362

(57) ABSTRACT

There is used a liquid ejection head including: a plurality of nozzles for ejecting liquid; a plurality of pressure chambers corresponding to the plurality of nozzles; a plurality of pressure generating elements arranged in the plurality of pressure chambers, and for generating a pressure for ejection; a plurality of first flow passages corresponding to the plurality of pressure chambers; a second flow passage communicating with the plurality of first flow passages, and common to the plurality of pressure chambers; and a damper that is elastically deformed when a pressure of the liquid is increased by the pressure generating element. The liquid is supplied to each of the plurality of pressure chambers from the common second flow passage via the plurality of first flow passages, and a Young's modulus of the second flow passage member configuring the second flow passage is 65 GPa or less.

### BACKGROUND OF THE INVENTION

### Field of the Invention

The present invention relates to a liquid ejection head.

### Description of the Related Art

In a liquid ejection device for performing recording on a recording medium by ejecting a liquid such as an ink from a nozzle, a liquid ejection head having a damper for suppressing the effect by a variation in pressure upon ejection has been widely used. Further, for manufacturing a liquid ejection head, a step of bonding a plurality of plates using an adhesive may be included. Japanese Patent No. 7131260 describes that spread of an adhesive onto a damper affects the damper performance. Thus, Japanese Patent No. 7131260 describes a liquid ejection head for stabilizing the damper performance by adding a member for reducing the adhesion of an adhesive onto a damper even when the adhesive is spread.

### SUMMARY OF THE INVENTION

Herein, as the method for reducing spread of an adhesive at the time of manufacturing a liquid ejection head, and suppressing the adhesion of an adhesive onto a damper, the method in which the flowability of the adhesive is reduced can also be considered other than the method for adding a member as in Japanese Patent No. 7131260. However, when the flowability of the adhesive is reduced, there is a fear that the sealability with respect to a liquid may be reduced.

The present invention was completed in view of the foregoing problem. It is an object of the present invention to provide a technology that enables combination of the reduction of adhesion of an adhesive onto a damper and ensuring of the sealability in manufacturing a liquid ejection head having a damper.

The present invention provides a liquid ejection head comprising:
a plurality of nozzles configured to eject liquid;
a plurality of pressure chambers corresponding to the plurality of nozzles, respectively, and for accommodating the liquid;
a plurality of pressure generating elements arranged in the plurality of pressure chambers, respectively, and for generating a pressure for ejecting the liquid;
a plurality of first flow passages corresponding to the plurality of pressure chambers, respectively;
a second flow passage communicating with the plurality of first flow passages, and common to the plurality of pressure chambers; and
a damper configured to be elastically deformed in a case where a pressure of the liquid is increased by the pressure generating element, wherein
the liquid is supplied to each of the plurality of pressure chambers from the common second flow passage via the plurality of first flow passages, and
a Young's modulus of a second flow passage member configuring the second flow passage is 65 GPa or less.

In accordance with the present invention, it is possible to provide a technology that enables combination of the reduction of adhesion of an adhesive onto a damper and ensuring of the sealability in manufacturing a liquid ejection head having a damper.

Further features of the present invention will become apparent from the following description of exemplary embodiments with reference to the attached drawings.

### BRIEF DESCRIPTION OF THE DRAWINGS

FIGS. 1A and 1B are each a cross sectional view showing an element substrate to be used for a liquid ejection head;

FIG. 2 is a perspective view showing a cross sectional configuration of a liquid ejection head;

FIGS. 3A to 3C are views showing various configuration examples of the element substrate to be used for a liquid ejection head;

FIGS. 4A to 4C are views showing various configuration examples of the element substrate to be used for a liquid ejection head;

FIGS. 5A to 5C are views showing various configuration examples of the element substrate to be used for a liquid ejection head;

FIGS. 6A to 6C are each a view showing one example of a method for manufacturing an element substrate;

FIGS. 7A and 7B are each a view showing one example of a method for manufacturing an element substrate;

FIGS. 8A to 8D are each a view showing another example of a method for manufacturing an element substrate;

FIGS. 9A and 9B are each a view showing a configuration of a liquid ejection head; and

FIG. 10 is a view showing an element substrate of a conventional example.

### DESCRIPTION OF THE EMBODIMENTS

Below, referring to the accompanying drawings, preferable embodiments of this invention will be described exemplarily in details. However, the dimensions, the shapes, the relative arrangement, and the like of the constituent components described in this embodiment are not intended to limit the scope of this invention only thereto unless otherwise specified. Further, the materials, the shapes, and the like once described in the following description are the same as those in the initial description also in a later description unless otherwise stated. The well-known technology or known technology of the present technical field is applicable to the configuration or the step not particularly shown nor described. Further, the present invention is not limited only to the embodiments, and further, all of the combinations of the features described in the present embodiment are not necessarily essential to the solving means of the present invention.

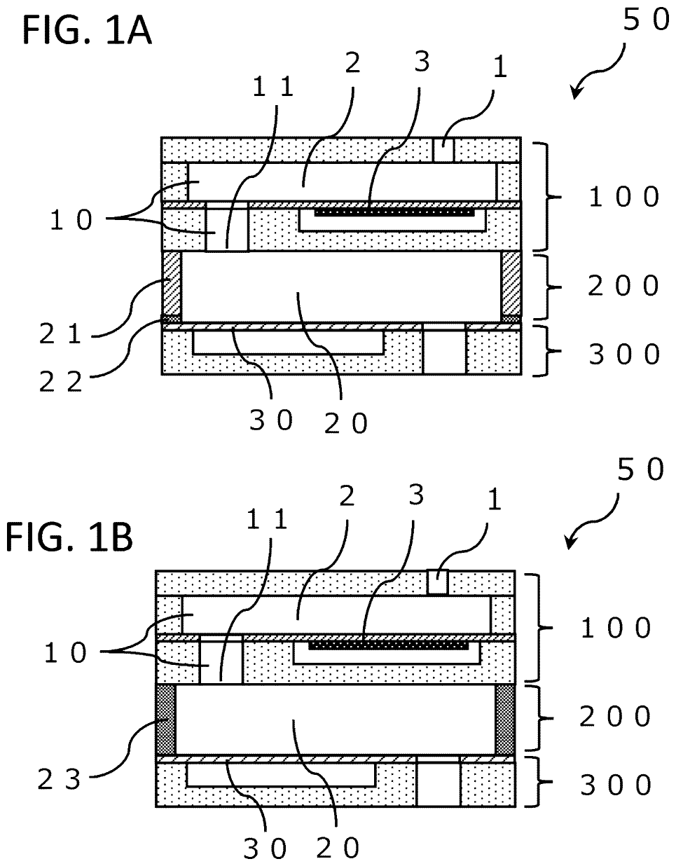

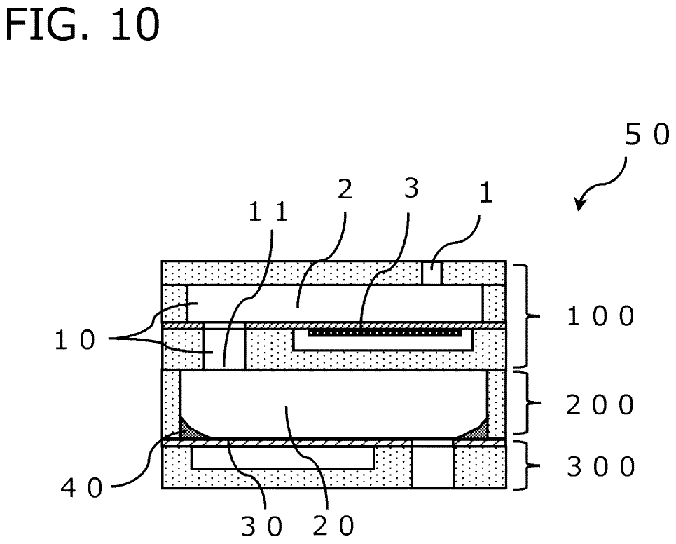

FIGS. 1A and 1B are each a cross sectional view showing one example of an element substrate 50 to be used for a liquid ejection head of an embodiment. Further, FIG. 10 is a cross sectional view showing one example of an element substrate 50 to be used for a conventional example.

As with Embodiment 1 shown in FIG. 1A, the element substrate 50 to be used for a liquid ejection head includes a lamination of a first flow passage member 100, a second flow passage member 200, and a damper flow passage member 300. The first flow passage member 100 has a nozzle 1 for ejecting a liquid such as an ink, a pressure chamber 2 communicating with the nozzle 1, for accommodating a liquid, and supplying the liquid to the nozzle 1, a first flow passage 10 communicating with the pressure chamber 2, and for allowing a liquid to pass therethrough, and an element 3 (pressure generating element). The element 3 has a pressure generating means for causing the pressure chamber 2 to generate a pressure. As the pressure generating means, a heat generating element, a piezoelectric element, or the like can be used. Further, the first flow passage member 100 includes a wire and a terminal not shown for transmitting an electric power or a driving signal to the pressure generating means. The first flow passage member 100 has a plurality of elements 3 provided in rows, and nozzles 1 in rows corresponding to respective elements 3, and the plurality of nozzles 1 form a nozzle row.

The second flow passage member 200 has a second flow passage 20 communicating with a first flow passage 10 via a first opening 11. The damper flow passage member 300 has a damper 30. Herein, the energy when a liquid is ejected from the pressure chamber 2, or the like may cause a variation in pressure at the element substrate 50. The inclusion of the damper 30 that is elastically deformed when a variation in pressure is caused can provide an effect of suppressing a variation in pressure. Namely, when the pressure of the liquid increases, the damper 30 is deformed. As a result, the volume of the whole liquid chamber including the pressure chamber 2, the first flow passage 10, the second flow passage 20, and the like increases. This absorbs the pressure. Upon completion of the ejection of the liquid, the shape of the deformed damper 30 returns to the original shape.

For a conventional liquid ejection head, as the member configuring the first flow passage member 100, the second flow passage member 200, or the damper flow passage member 300, single crystal Si or SUS (stainless steel) is often used. Although the Young's modulus of the single crystal Si has the dependency on the crystal orientation, it is about 130 to 190 GPa. Further, the Young's modulus of SUS is about 200 GPa. When the flow passage members are formed with the members that each have a high Young's modulus, and are less likely to be deformed, and then, respective flow passage members are joined, in order to ensure the sealability, the adhesive 40 is often formed as thick as several tens of micrometers to several hundreds of micrometers. As a result, as shown in FIG. 10, the spread of the adhesive 40 may adhere to the damper 30.

### Configuration

FIG. 1A shows one example of the configuration of the element substrate 50 of the present embodiment. Herein, the second flow passage member 200 is formed with a member having a low Young's modulus. As a result of this, the second flow passage member 200 becomes more likely to be deformed. This provides an effect of facilitating ensuring of the sealability even with a smaller amount of the adhesive 40 as compared with a member having a higher Young's modulus.

A description will be given to the preferable characteristics when the flow passage member of the present embodiment is formed with the same configuration, dimensions, and manufacturing method as those of a conventional flow passage member. The flow passage member of the present embodiment preferably has a Young's modulus of 65 GPa or less that can increase the deformation amount by 2 to 3 times relative to the flow passage member for use in a conventional configuration. Further, the flow passage member of the present embodiment more preferably has a Young's modulus of 32.5 GPa or less that can double the deformation amount relative to the flow passage member for use in a conventional configuration. Furthermore, the flow passage member of the present embodiment more preferably has a Young's modulus of 10 GPa or less that can provide an effect of enabling an increase in deformation amount by using a resin, and facilitating manufacturing thereof relative to the flow passage member for use in a conventional configuration. Still further, the flow passage member of the present embodiment more preferably has a Young's modulus of 5 GPa or less that can provide an effect of making the damage upon deformation less likely to be caused by the use of a resin not including a filler relative to the flow passage member for use in a conventional configuration.

On the other hand, a higher Young's modulus provides a larger effect of suppressing the flow of the adhesive 40. For this reason, when the Young's modulus is set too low, the flowability of the adhesive 40 becomes too high. This may result in a larger spread amount. Thus, preferably, by increasing the Young's modulus to a certain degree, the effect of suppressing the spread of the adhesive 40 is enhanced. Typically, the Young's modulus of the flow passage member is preferably set at 0.1 GPa or more. A Young's modulus of 0.5 GPa or more enhances the effect of suppressing the flowability, and hence is more preferable.

In the present embodiment, the second flow passage member 200 includes a second flow passage configuring member A21 and a second flow passage configuring member B22. By configuring the second flow passage configuring member A with a member having a low Young's modulus, and enhancing the sealability, it becomes possible to use the adhesive 40 which is about 1/10th to 1/100th thinner than conventional configurations as the second flow passage configuring member B. This enables the reduction of the spread of the adhesive 40.

A thickness of the second flow passage member 200 of 50 μm or more tends to provide an effect of enhancing the sealability, and hence is preferable. A thickness of 100 μm or more increases the effect of enhancing the sealability, and hence is more preferable. A thickness of 200 μm or more further increases the effect of enhancing the sealability, and hence more preferable. When the second flow passage member 200 with such a thickness is formed with the adhesive 40 of the conventional method, the spread is difficult to reduce because of high flowability. On the other hand, when the thickness of the second flow passage member 200 is 500 μm or less, the damper performance tends to be ensured. For this reason, the thickness is preferable. Further, when the thickness of the second flow passage member 200 is at least one time and not more than 20 times the length of the long side of the first opening 11 assuming that the cross section of the first opening 11 has a rectangular shape having long sides and short sides, the damper performance tends to be ensured. For this reason, the thickness is preferable. When the damper 30 faces the second flow passage 20, the effect of suppressing a variation in pressure can be provided. Especially, with the configuration in which the damper 30 is formed at the surface opposed to the surface having the first opening 11 communicating with the first flow passage 10 of the wall surfaces configuring the second flow passage 20, the effect of suppressing a variation in pressure is enhanced. For this reason, the configuration is more preferable. The first flow passage 10 being an individual flow passage with respect to the nozzle 1 makes the effect of a variation in pressure on other nozzles arranged in the nozzle row direction less likely to be transmitted, so that the effect of stabilizing ejection can be provided. For this reason, this configuration is preferable. Further, the second flow passage 20 being a common flow passage to a plurality of nozzles 1 enables the formation of the large common flow passage, which enables widening of the width of the damper. As a result, the effect of suppressing a variation in pressure can be enhanced. Accordingly, preferably, the first flow passage 10 is an individual flow passage with respect to the nozzle 1, and the second flow passage 20 is a common flow passage with respect to a plurality of nozzles 1.

FIG. 1B shows another configuration example of the element substrate 50 as Embodiment 2. Herein, the second flow passage member 200 includes a second flow passage configuring member C23. Then, the second flow passage configuring member C also serves as an adhesive, which provides an effect of enabling the suppression of the spread of the adhesive. At the time of forming the second flow passage configuring member C23, materials having thermoplasticity may be patterned, followed by joining using heat to be used. Alternatively, the member to be cured by a chemical reaction may be patterned while being partially cured, followed by joining to progress the curing reaction. A material whose curing reaction is progressed after joining is more likely to be enhanced in joint strength, and hence is more preferable. The second flow passage member 200 having low flowability and having adhesion enables combination of the reduction of the spread and ensuring of the sealability, and hence is more preferable.

To the joining member, a filler may be added. A fibrous filler having a high effect of suppressing the defects such as breakage of the joining member is preferable. For example, a carbon fiber a metal fiber, a glass fiber, or a cellulose fiber can be used.

The second flow passage member 200 including a member to be cured by a chemical reaction in an amount of 50% or more as the proportion accounting for the thickness or the volume of the second flow passage member 200 facilitates an increase in joint strength, and hence is preferable. A proportion of 100% is still further more likely to enhance the joint strength, and hence is more preferable. The chemical reaction facilitates patterning because the curing member is a photosensitive resin, which can provide an effect of facilitating manufacturing. A negative type photosensitive resin is more likely to enhance the chemical resistance than a positive type photosensitive resin, and hence is more preferable.

For the second flow passage member 200, epoxy, acryl, urethane, silicone, benzocyclobutene, polyimide, polyamide, polyamideimide, cyanoacrylate, phenol, melamine, styrene, or cyclized rubber, or a mixture thereof, or the like can be used. Out of these, a resin including epoxy, silicone, benzocyclobutene, or polyimide, as the main component, that is excellent in chemical resistance, is preferable.

The epoxy has no particular restriction. For example, a bisphenol type epoxy, a novolak type epoxy, an epoxy polyol type epoxy, an alicyclic epoxy, a glycidyl type epoxy, a urethane modified epoxy, a chelate modified epoxy, or a rubber modified epoxy, or a mixture thereof can be used.

Silicone has no particular restriction. For example, a condensation type silicone or an addition type silicone can be used. Out of these, an addition type silicone less undergoing curing shrinkage is preferable. For example, an epoxy modified silicone, an acryl modified silicone, a methyl type silicone, a phenyl type silicone, a methyl phenyl type silicone, an alkyd modified silicone, or a polyester modified silicone, or a mixture thereof can be used.

Although benzocyclobutene has no particular restriction, CYCLOTENE series manufactured by Dow Inc., or the like can be used.

Although polyimide has no particular restriction, polyimide having thermoplasticity may be used in a film shape, or polyamic acid may be used as a precursor.

A coupling agent may be included at the interface between the second flow passage member 200 and the first flow passage member 100, or at the interface between the second flow passage member 200 and the damper flow passage member 300. By selecting a coupling agent according to the member, it is possible to form a covalent bond. This can provide an effect of enhancing the joint strength.

### Cross Sectional Configuration

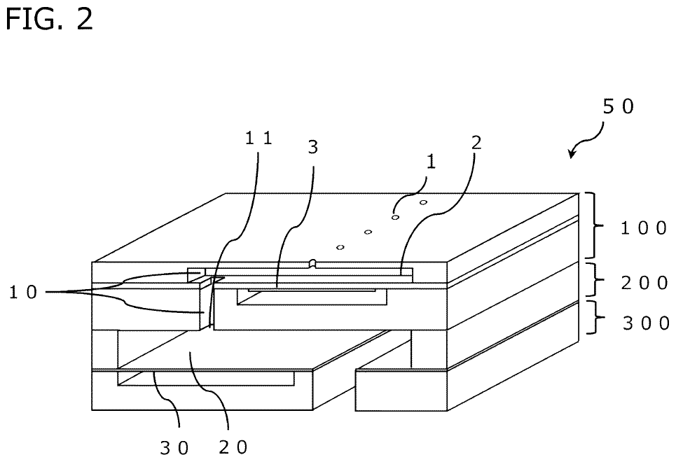

FIG. 2 is a view showing one example of the element substrate 50 for use in a liquid ejection head, and shows a cross sectional perspective view. As shown in FIG. 2, the first flow passage 10 is an individual flow passage, and has a structure to be connected with the common flow passage that is the second flow passage 20 at the first opening 11. The present configuration is a preferable configuration as the present invention. However, the present invention is not limited to the present structure.

### Another Embodiment

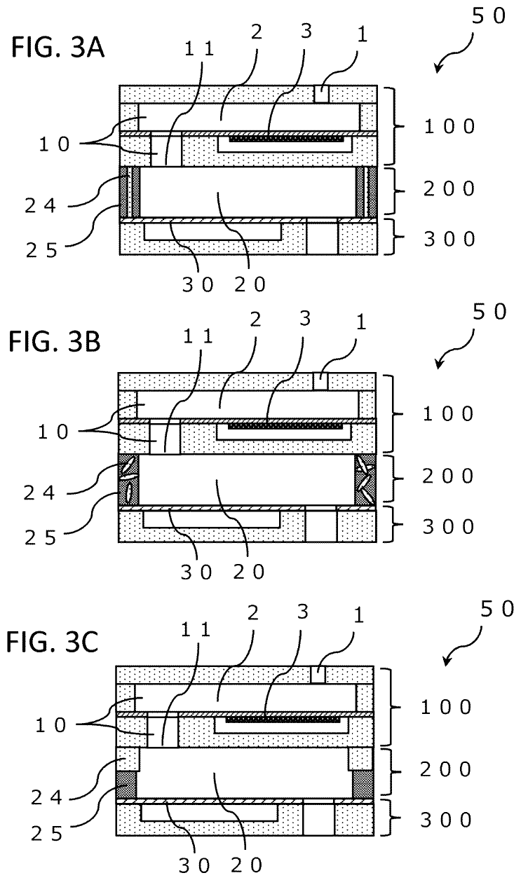

FIGS. 3A to 3C to 5A to 5C are views showing various configuration examples of the element substrate 50 for use in the liquid ejection head of the present invention.

As with Embodiment 3 shown in FIG. 3A, Embodiment 4 shown in FIG. 3B, and Embodiment 5 shown in FIG. 3C, the second flow passage member 200 may include a second flow passage configuring member D24 and a second flow passage configuring member E25. A Young's modulus of the second flow passage configuring member E25 of 65 GPa or less can provide the effect of the present invention, and hence is preferable. A thickness of 50 μm or more can provide the effect of enhancing the sealability, and hence is more preferable. The second flow passage configuring member D24 may be used in a columnar shape, a filler shape, or a lamination.

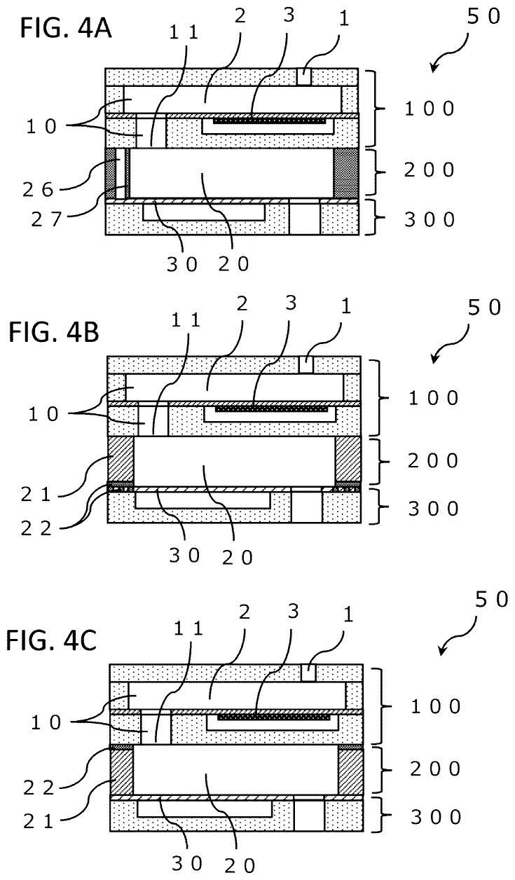

As with Embodiment 6 shown in FIG. 4A, the second flow passage member 200 may have a cavity 26. By adopting such a structure, it becomes possible to use a part 27 of the second flow passage member 200 as an auxiliary damper. By forming the cavity 26 at least on the side close to the first opening 11, it is possible to enhance the effect as the auxiliary damper.

As with Embodiment 7 shown in FIG. 4B, the following configuration may be used: the damper flow passage member 300 is processed, so that the second flow passage configuring member 22 having an adhesion function of the second flow passage member 200 enters the damper flow passage member 300. By adopting such a configuration, it is possible to enhance the adhesion strength by the anchor effect. Further, according to the configuration of the member, it becomes easy to select the configuration in which a chemical bond is easy to form at the interface between a part of the second flow passage member 200 and the damper flow passage member 300. This can provide an effect of enhancing the adhesion strength.

As with Embodiment 8 shown in FIG. 4C, the second flow passage configuring member 22 having the adhesion function of the second flow passage member 200 may be used for the interface with the first flow passage member 100.

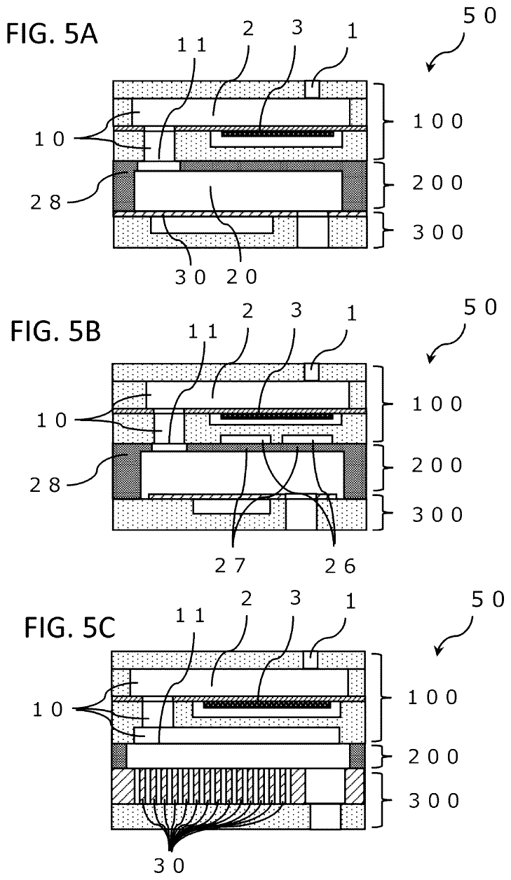

As with Embodiment 9 shown in FIG. 5A, by forming the second flow passage configuring member F28 so as to cover the second flow passage 20, it is possible to increase the junction area with the first flow passage member 100, which can provide the effect of enhancing the adhesion strength. Herein, when it is configured such that the first flow passage 10 has an individual flow passage for each nozzle, the second flow passage configuring member F28 may have an opening corresponding to the first opening 11. This can provide the effect of being capable of enhancing the degree of freedom of the manufacturable structure.

As with Embodiment 10 shown in FIG. 5B, the following configuration is also acceptable: the first flow passage member 100 has a portion to be the cavity 26, and a portion 27 of the second flow passage configuring member F28 covering the cavity 26 is used as an auxiliary damper. The auxiliary damper may be divided into a plurality of rows. It may be configured such that the damper at the adhesion portion between the second flow passage configuring member F28 and the damper flow passage member 300 is patterned to be removed. This results in an increase in degree of freedom of the configuration of the member. For this reason, it becomes easy to select the configuration in which a chemical bond is easy to form, resulting in the effect of enhancing the adhesion strength.

As with Embodiment 11 shown in FIG. 5C, it may be designed such that the first opening 11 in the first flow passage 10 formed in the first flow passage member 100 is widened. For example, design can be achieved in consideration of the flow resistance of the liquid. The damper 30 formed at the damper flow passage member 300 may be formed so as to be arranged perpendicular to the surface having the first opening 11.

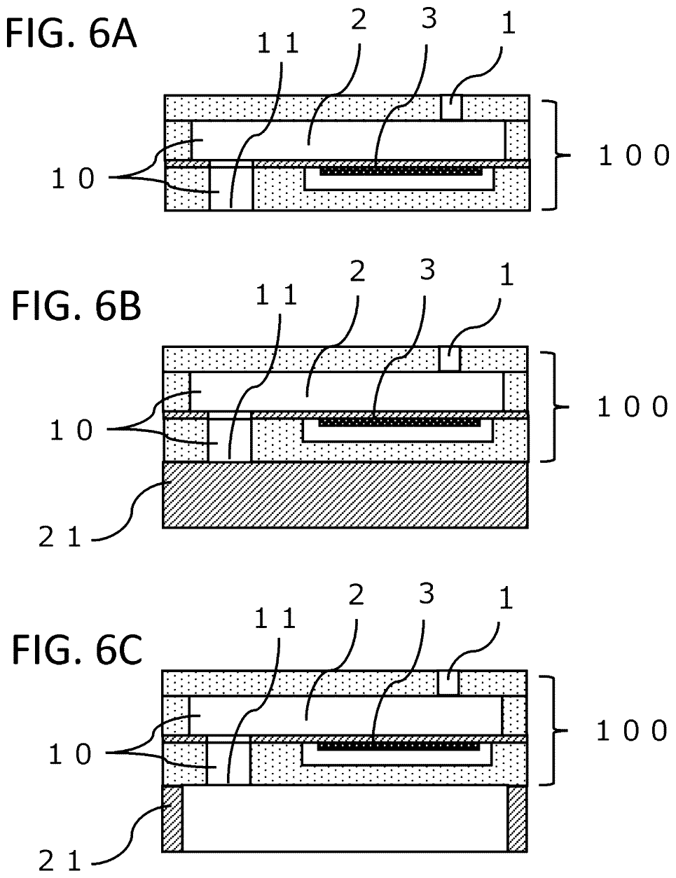

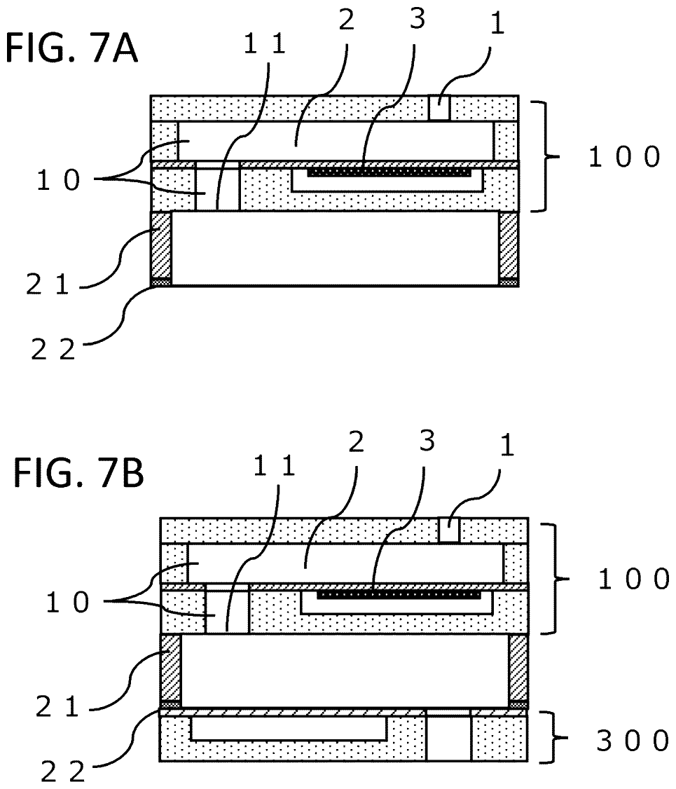

FIGS. 6A to 6C and FIGS. 7A and 7B are each a view showing one example of the method for manufacturing the element substrate 50 of a liquid ejection head. Herein, an example of manufacturing the element substrate 50 of FIG. 1A will be shown.

As shown in FIG. 6A, a first flow passage member 100 is prepared.

As shown in FIG. 6B, a first joining step of joining the second flow passage configuring member A21 to the first flow passage member 100 is performed. In the first joining step, by transferring a second flow passage configuring member A21 as a dry film, it is possible to obtain the effect of facilitating the step. Further, the formation with a dry film can also provide an effect of facilitating the enhancement of the thickness precision.

As shown in FIG. 6C, the second flow passage configuring member A21 is patterned. By using a negative type photosensitive resin as a dry film, it is possible to form a pattern with more ease by exposure, PEB: Post exposure bake, and development. Herein, processing can be achieved by etching using a mask pattern. However, the first flow passage member 100 may tend to be damaged by overetching. For this reason, the formation is preferably achieved using a dry film.

As shown in FIG. 7A, an adhesive is transferred as a second flow passage configuring member B22. In order to reduce the spread of the adhesive, the thickness of the adhesive before joining is preferably set at 1 μm or less, and is more preferably set at 0.5 μm or less.

As shown in FIG. 7B, a damper flow passage member 300 is joined, and curing is performed.

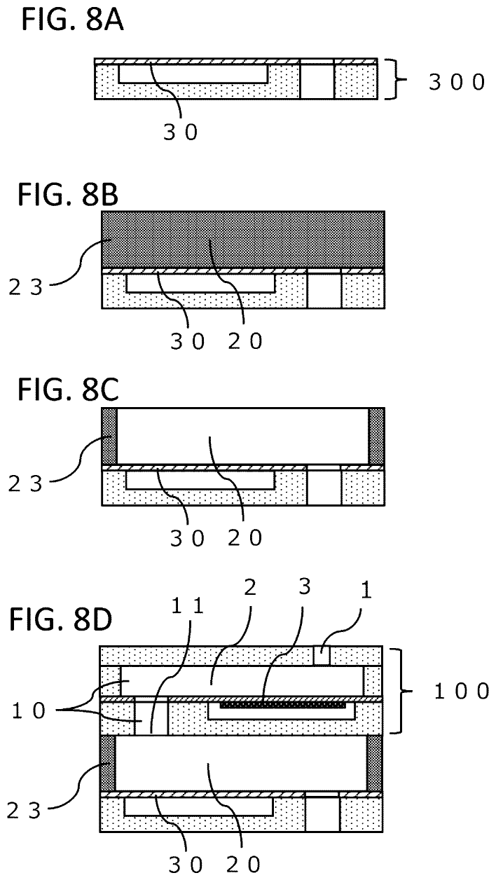

FIGS. 8A to 8D are views showing another example of the method for manufacturing the element substrate 50 of a liquid ejection head. Herein, an example of manufacturing the element substrate 50 of FIG. 1B will be shown.

As shown in FIG. 8A, a damper flow passage member 300 is prepared.

As shown in FIG. 8B, a second flow passage configuring member C23 is transferred as a dry film. For the second flow passage configuring member C23, a material to be cured by a chemical reaction is preferable, and a photosensitive material such as epoxy having negative type photosensitivity can be used. Before transferring the second flow passage configuring member C23, a silane coupling agent adaptable to a damper material and epoxy is applied to the damper flow passage member 300, and is baked. This facilitates the formation of a chemical bond at the interface. The dry film is applied onto the film of polyethylene terephthalate serving as the base material by spin coating, and is baked, thereby to be formed. The thickness of one layer of the dry film is set at 50 μm, and 3 layers thereof are stacked to be transferred. As a result, the second flow passage configuring member C23 is formed with a thickness of 150 μm.

As shown in FIG. 8C, the second flow passage configuring member C23 is patterned by exposure, baking after exposure, and development.

As shown in FIG. 8D, the first flow passage member 100 is joined, and curing is performed. Before joining, a silane coupling agent adaptable to the first flow passage member 100 and epoxy is applied to the first flow passage member 100, and is baked. This facilitates the formation of a chemical bond at the interface. Incidentally, a Young's modulus of the first flow passage member 100 also serving as the adhesive of 0.1 GPa or more enhances the effect of suppressing the spread of the adhesive, and hence is preferable.

### Applied Example

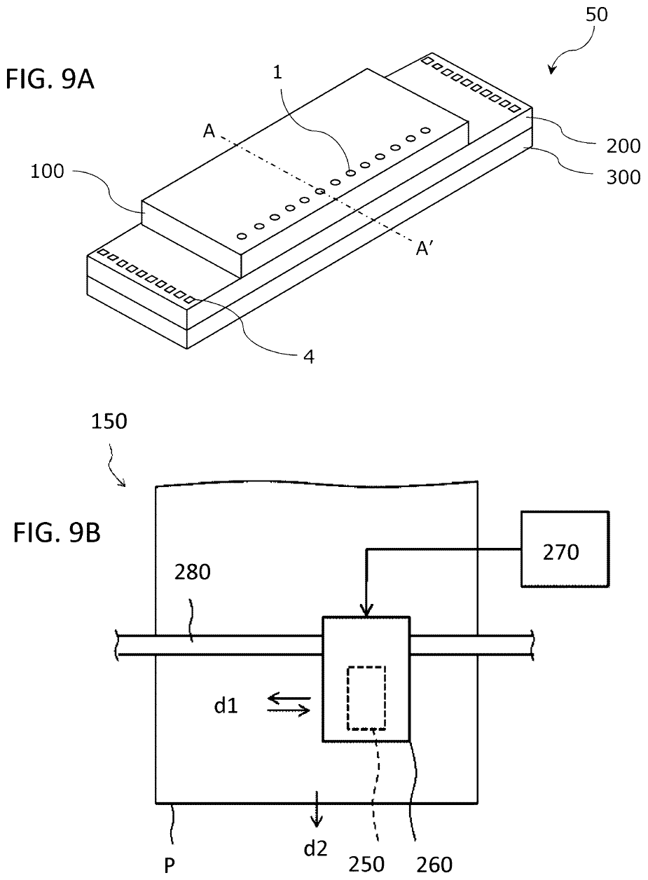

An example in which the element substrate 50 of an embodiment is applied to a liquid ejection head or a liquid ejection device will be shown. FIG. 9A is a schematic perspective view of the element substrate 50. The element substrate 50 is configured of a lamination of the first flow passage member 100 provided with the nozzle 1, the second flow passage member 200, and the damper flow passage member 300. Further, on the second flow passage member 200, an electric connection part 4 that is a terminal for establishing a connection with electric wiring is formed.

FIG. 9B is a schematic view showing a configuration of an ink jet system liquid ejection device 150 (recording device). The liquid ejection device 150 includes a liquid ejection head 250 (recording head) provided with the element substrate 50, a carriage 260, and a controller 270 that is a control part for performing driving and control thereof. The liquid ejection head 250 drives the individual elements 3 on the basis of a control signal from the controller 270. As a result, the liquid in the pressure chamber 2 applied with an energy is ejected from the nozzle 1. Thus, recording (image formation) with respect to a recording medium P such as paper is carried out.

The carriage 260 for supporting the liquid ejection head 250 is reciprocated in the direction of an arrow dl along a guide 280 on the basis of a control signal from the controller 270. The recording medium P is transported in a direction d2 by a transport mechanism included in the liquid ejection device 150. The controller 270 performs driving and control of the liquid ejection head 250 while reciprocating the carriage 260. As a result, a desired image can be recorded on the recording medium P.

By mounting the element substrate 50 on the liquid ejection head 250, the liquid ejection device 150 can be manufactured. Use of such a liquid ejection head 250 and a liquid ejection device 150 results in less adhesion of the adhesive onto the damper 30, and high sealability. For this reason, recording with high reliability can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-003362, filed on Jan. 12, 2024, which is hereby incorporated by reference wherein in its entirety.

What is claimed is:

1. A liquid ejection head comprising:
a plurality of nozzles configured to eject liquid;
a plurality of pressure chambers corresponding to the plurality of nozzles, respectively, and for accommodating the liquid;
a plurality of pressure generating elements arranged in the plurality of pressure chambers, respectively, and for generating a pressure for ejecting the liquid;
a plurality of first flow passages corresponding to the plurality of pressure chambers, respectively;
a second flow passage communicating with the plurality of first flow passages, and common to the plurality of pressure chambers; and
a damper configured to be elastically deformed in a case where a pressure of the liquid is increased by the pressure generating element, wherein
the liquid is supplied to each of the plurality of pressure chambers from the common second flow passage via the plurality of first flow passages, and
a Young's modulus of a second flow passage member configuring the second flow passage is 65 GPa or less.

2. The liquid ejection head according to claim 1, wherein
the second flow passage member has a Young's modulus of 32.5 GPa or less.

3. The liquid ejection head according to claim 1, wherein
the second flow passage member has a Young's modulus of 10 GPa or less, and a material thereof includes a resin.

4. The liquid ejection head according to claim 1, wherein
the second flow passage member has a Young's modulus of 5 GPa or less, and a material thereof includes a resin not including a filler.

5. The liquid ejection head according to claim 1, wherein
the second flow passage member has a Young's modulus of 0.1 GPa or more.

6. The liquid ejection head according to claim 1, wherein
the second flow passage member has a Young's modulus of 0.5 GPa or more.

7. The liquid ejection head according to claim 1, wherein
the second flow passage member has a thickness of 50 μm or more.

8. The liquid ejection head according to claim 1, wherein
the second flow passage member has a thickness of 100 μm or more.

9. The liquid ejection head according to claim 1, wherein
the second flow passage member has a thickness of 200 μm or more.

10. The liquid ejection head according to claim 1, wherein
the second flow passage member has a thickness of 500 μm or less.

11. The liquid ejection head according to claim 1, wherein
the second flow passage and the first flow passage communicate with each other via an opening having a rectangular shape in cross section, and
the second flow passage member has a thickness at least 1 time and not more than 20 times a length of a long side of the opening.

12. The liquid ejection head according to claim 1, wherein
of wall surfaces configuring the second flow passage, the damper is formed at a surface opposed to a surface having an opening communicating with the first flow passage.

13. The liquid ejection head according to claim 1, wherein
the second flow passage member also serves as an adhesive.

14. The liquid ejection head according to claim 1, wherein
the second flow passage member includes a member to be cured by a chemical reaction in an amount equivalent to 50% or more of a thickness or volume of the second flow passage member.

15. The liquid ejection head according to claim 14, wherein
the member to be cured by a chemical reaction is a negative type photosensitive resin.

16. The liquid ejection head according to claim 14, wherein
the second flow passage member includes epoxy, silicone, benzocyclobutene, or polyimide, or a mixture thereof.

17. The liquid ejection head according to claim 1, wherein
the liquid ejection head has a portion for forming a covalent bond at an interface between the second flow passage member and a member configuring the first flow passage, or, an interface between the second flow passage member and a member configuring the damper.

18. The liquid ejection head according to claim 1, wherein
of a plurality of members configuring the second flow passage, at least a member close to an opening for allowing the second flow passage and the first flow passage to communicate with each other has a cavity.
